(19) United States
(12) Patent Application Publication
(10) Pub. No.: US 2019/0288462 A1
(43) Pub. Date: Sep. 19, 2019

(54) MANUFACTURING METHOD FOR ALUMINIUM COAXIAL CABLE WITH COAXIAL CONNECTOR

(71) Applicant: UBCS CO., LTD., Suwon-si (KR)

(72) Inventor: SUNG KWON KIM, Suwon-si (KR)

(73) Assignee: UBCS CO., LTD., Suwon-si (KR)

(21) Appl. No.: 16/296,220

(22) Filed: Mar. 8, 2019

(30) Foreign Application Priority Data
Mar. 14, 2018 (KR) 10-2018-0029761

(51) Int. Cl. H01R 24/38; H01R 43/00

(52) U.S. Cl. CPC H01R 24/38; H01R 43/00

(57) ABSTRACT

Provided is a manufacturing method for an aluminum coaxial cable provided with a coaxial connector, which includes a coaxial cable including an inner conductor having a predetermined length, an insulating portion covering the outside of the inner conductor in a longitudinal direction of the inner conductor, an outer conductor covering the outside of the insulating portion in the longitudinal direction of the inner conductor, a jacket portion covering the outside of the outer conductor in the longitudinal direction of the inner conductor, and a connection pin provided with an insertion groove to which the end of the inner conductor is inserted; and a coaxial connector including a connector main portion which has the other side opened so that the outer conductor end is inserted and has an installation groove in which the inner portion is hollow, and a clamp portion provided outside the connector main portion. The manufacturing method for an aluminum coaxial cable provided with a coaxial connector includes: removing the jacket portion to a first predetermined length so that the outer conductor is exposed to the outside; removing the outer conductor and the insulating portion to a second predetermined length so that the inner conductor is exposed to the outside while the outer conductor is exposed to a third predetermined length; applying a flux to the exposed inner conductor end; pre-fixing the inner conductor end applied with the flux which is inserted to the insertion hole of the connection pin after injecting a predetermined amount of lead to the insertion hole of the connection pin; and coupling the inner conductor and the connection pin by supplying a high frequency to a portion where the inner conductor and the connection pin are coupled to each other.

### CROSS-REFERENCE TO RELATED APPLICATIONS

The present application claims the benefit of Korean Patent Application No. 10-2018-0029761 filed on Mar. 14, 2018, in the Korean Intellectual Property Office, the entire contents of which are hereby incorporated by reference.

### TECHNICAL FIELD

The present invention relates to a coaxial cable and more particularly, to a manufacturing method for an aluminum coaxial cable which is used in a mobile communication field and provided with a coaxial connector so that main configurations are coupled to each other by a soldering method.

### BACKGROUND ART

Generally, a coaxial cable provided with a coaxial connector has been applied to mobile communication equipment and the like using a high frequency. In addition, the high-frequency connector has two major characteristics, in which one thereof is to fit an impedance value to the cable well as an element capable of transmitting high-frequency electric characteristics well and the other one is a characteristic capable of ensuring reliably the connection as the term of the connector itself, and a key of design is to satisfy these two elements at the same time.

Meanwhile, the coaxial cable provided with the coaxial connector is required to have an integral shape of a coupling part to increase the durability of the coupling part and improve the reliability of communication.

However, in the related art, the coaxial cable and the coaxial connector are manually assembled to deteriorate the assemblability, and needs to be assembled manually by a mechanical method, and thus a lot of defects occur.

In addition, there is a case where an aluminum material is used for the purpose of reducing the weight, etc., and in this case, there is a problem that coupling force is deteriorated through general lead welding.

### DISCLOSURE

### Technical Problem

The present invention has been made in order to solve the above-mentioned problems and drawbacks of the prior art, and an object of the present invention is to provide a manufacturing method for a coaxial cable in which main configurations are firmly coupled to each other by a soldering method in a coaxial cable provided with a coaxial connector.

Another object of the present invention is to provide a manufacturing method for a coaxial cable in which flux and lead applied to a soldering method are arranged at appropriate positions and thicknesses between main configurations.

The objects of the present invention are not limited to the aforementioned objects, and other objects, which are not mentioned above, will be apparent to a person having ordinary skill in the art from the following description.

### Technical Solution

In order to achieve the objects, there is provided a manufacturing method for an aluminum coaxial cable provided with a coaxial connector, which includes a coaxial cable including an inner conductor having a predetermined length, an insulating portion covering the outside of the inner conductor so that the end of the inner conductor is exposed to the outside, an outer conductor covering the outside of the insulating portion, a jacket portion covering the outside of the outer conductor, and a connection pin connected to the end of the inner conductor; and a coaxial connector including a connector main portion to which the end of the outer conductor is inserted, the manufacturing method including: applying a flux to the exposed end of the inner conductor; and coupling the inner conductor and the connection pin by heating a portion where the inner conductor and the connection pin are coupled to each other after injecting a predetermined amount of lead between the connection pin and the inner conductor end.

The connection pin may have an insertion groove to which the end of the inner conductor is inserted, and the lead may be injected to the insertion groove.

The portion where the inner conductor and the connection pin are coupled to each other may be applied with high-frequency heating.

The manufacturing method may further include applying a flux to the end of the outer conductor; inserting the outer conductor end applied with the flux into the connector main portion; and providing lead at the outside of the outer conductor to a position adjacent to the connector main portion.

The lead provided at the outside of the outer conductor may be formed of string-shaped thin lead and the thin lead may be wound around the outer conductor to be adjacent to the outside of the connector main portion.

The inner conductor may include a central portion made of an aluminum material; and an external skin portion made of a brass material and covering the central portion.

### Advantageous Effects

According to the manufacturing method for the aluminum coaxial cable provided with the coaxial connector according to the embodiment of the present invention, it is possible to enable the coupling operation using the lead by using the flux when coupling the coaxial cable and the coaxial connector.

Further, it is possible to improve the product reliability and reduce the product defect rate by eliminating a simple mechanical coupling and inducing the integral coupling of the configurations using the flux.

The effects of the present invention are not limited to the aforementioned effect, and other effects, which are not mentioned above, will be apparent to a person having ordinary skill in the art from the description of the claims.

### DESCRIPTION OF DRAWINGS

FIG. 1 is a perspective view illustrating a coaxial cable provided with a coaxial connector according to an embodiment of the present invention;

FIG. 2 is a view illustrating a state where a coaxial cable and a connection pin are connected to each other;

FIG. 3 is a perspective view illustrating a coaxial connector;

FIG. 4 is a side cross-sectional view illustrating a coaxial cable provided with a coaxial connector according to an embodiment of the present invention;

FIG. 5 is a perspective view illustrating a coaxial cable in an initial state;

FIG. 6 is a perspective view illustrating a state in which a front-closed circular board is inserted into a coaxial cable in which an inner conductor is exposed;

FIG. 7 is a view schematically illustrating a state in which flux is applied to an end of the inner conductor;

FIG. 8 is a perspective view schematically illustrating a coupling device for coupling a connection pin and an inner conductor;

FIG. 9 is a view schematically illustrating a state in which a connection pin is installed in the coupling device illustrated in FIG. 8 and lead is injected;

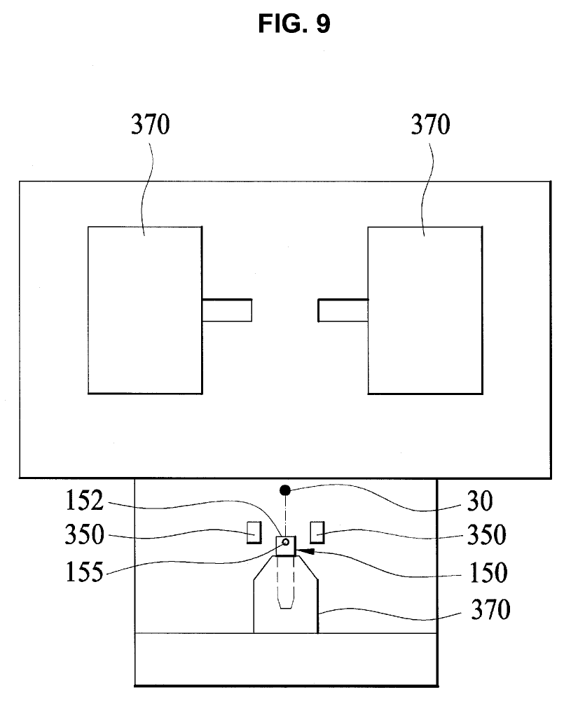

FIG. 10 is a view schematically illustrating a state in which a connection pin is coupled to an inner conductor end using the coupling device illustrated in FIG. 8;

FIG. 11 is a perspective view illustrating a coaxial cable to which a flux is applied to an outer conductor end;

FIG. 12 is a perspective view illustrating a state where the coaxial connector is installed on the coaxial cable illustrated in FIG. 11 and then thin lead is wound;

FIG. 13 is a perspective view schematically illustrating a coupling device for coupling a coaxial cable and a coaxial connector;

FIG. 14 is a view schematically illustrating a state in which the coaxial cable and the coaxial connector are coupled to each other using the coupling device illustrated in FIG. 13;

FIG. 15 is a view for describing a state in which thin lead is melted and injected using a second air passage hole; and

FIG. 16 is a block diagram sequentially illustrating a process of manufacturing a coaxial cable provided with a coaxial connector according to an embodiment of the present invention.

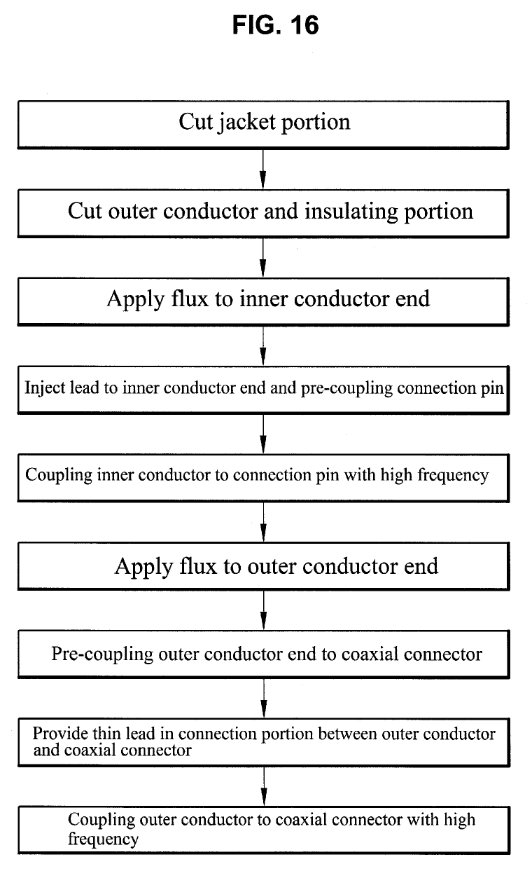

### MODES OF THE INVENTION

Hereinafter, an embodiment of the present invention, in which a purpose of the present invention can be realized in detail will be described with reference to the accompanying drawings. In describing the embodiment, the same name and the same reference numeral are used with respect to the same component and the resulting additional description will be omitted. First, configurations and functions according to a preferred embodiment of the present invention will be described with reference to the accompanying drawings.

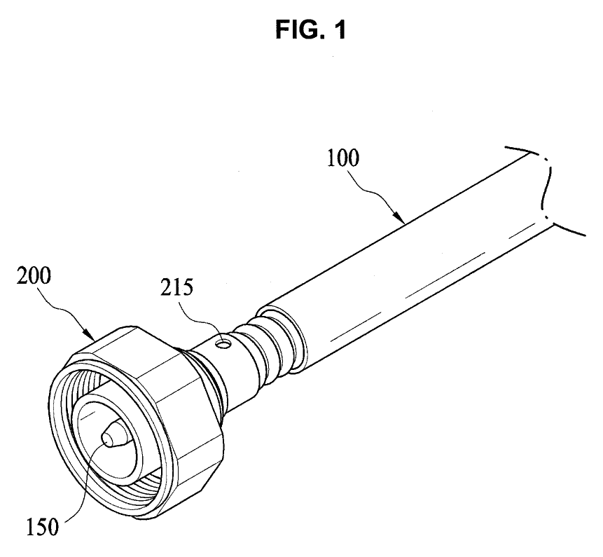

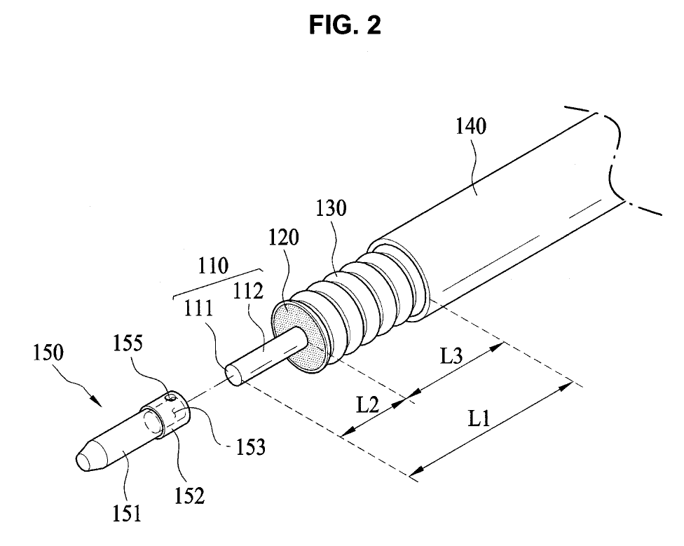

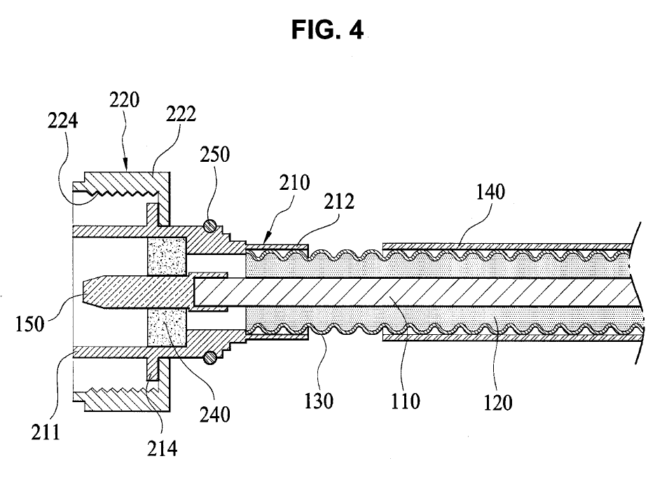

FIG. 1 is a perspective view illustrating a coaxial cable provided with a coaxial connector according to an embodiment of the present invention, FIG. 2 is a view illustrating a state where a coaxial cable and a connection pin are connected to each other, and FIG. 2 is a view illustrating a state where a coaxial cable and a connection pin are connected to each other. In addition, FIG. 4 is a side cross-sectional view illustrating a coaxial cable provided with a coaxial connector according to an embodiment of the present invention.

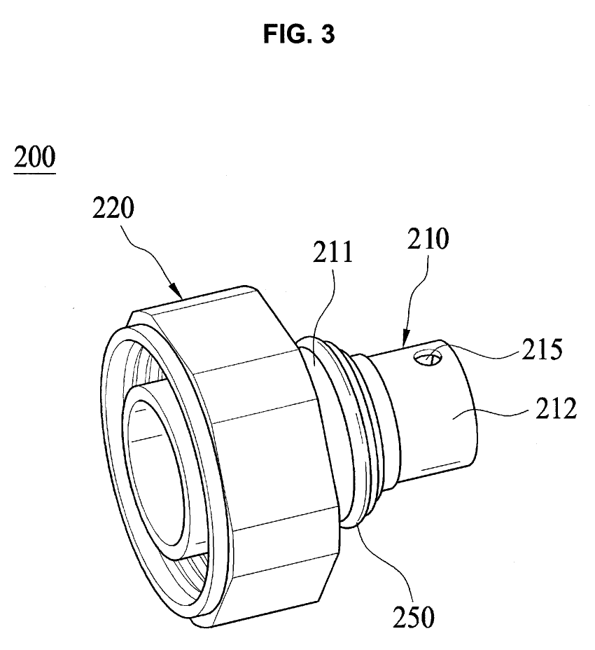

As illustrated in FIGS. 1 to 4, the coaxial cable 100 according to the present invention includes an inner conductor 110 which has a predetermined length and an inner-closed rod shape, an insulating portion 120 which covers the outside of the inner conductor 110 in a longitudinal direction, an outer conductor 130 which covers the outside of the insulating portion 120 in a longitudinal direction, and a jacket portion 140 which covers the outside of the outer conductor 130 in the longitudinal direction.

The inner conductor 110 includes a central portion 111 made of an aluminum material and an outer skin portion 112 made of a brass material and covering the outside of the central portion 111 in the longitudinal direction, and the outer conductor 130 is made of an aluminum material. The insulating portion 120 is made of a synthetic resin material that is applied to a coaxial cable in the related art, and the jacket part 140 is made of a rubber material.

Meanwhile, a connection pin 150 is provided at an end of the inner conductor 110. The connection pin 150 includes a connection portion 152 formed of a metallic material and having an insertion groove 153 into which the end of the inner conductor 110 is inserted and a fin portion 151 integrally formed with the connection portion 152. Here, the connection portion 152 includes a first air passage hole 155 through which the insertion groove 153 and the outside pass.

Next, the coaxial connector 200 includes a connector main portion 210 and a coupling nut portion 220.

The connector main portion 210 includes an inner tube portion 212 having a diameter in which a rear side thereof is opened so that the outer conductor 130 can be inserted to the inside and an outer tube portion 211 which is connected with the inner tube portion 212 toward the front side and has a larger diameter than the inner tube portion 212.

The coupling nut portion 220 is installed outside the outer tube portion 211 and is movable along the longitudinal direction of the outer tube portion 211.

A stopper portion 214 and a stopper ring 250 are provided outside the outer tube portion 211 so that the coupling nut portion 220 is movable between predetermined intervals in the longitudinal direction of the outer tube portion 211. The coupling nut portion 220 has a thread portion 224 formed on an inner side thereof to be screwed into an external connection terminal or a connector, and has a nut body portion 222 having a double-curved shape as illustrated in the drawing.

The configuration of the coaxial connector 200 coupled to the coaxial cable 100 may be partially modified in some forms of known various forms and it is obvious to those skilled in the art, so that a detailed description thereof will be omitted.

Hereinafter, a manufacturing method for the coaxial cable 100 configured above by coupling the connection pin and the coaxial connector 200 will be described.

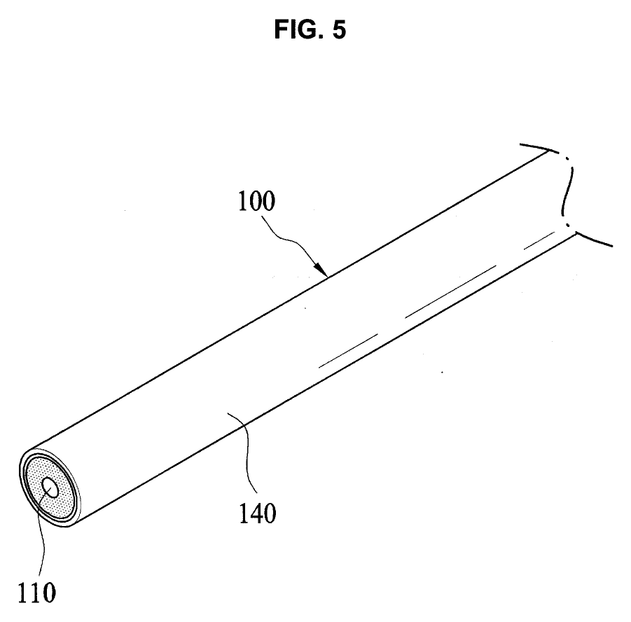

As illustrated in FIG. 5 in which the initial coaxial cable is manufactured, in the initial state, the jacket portion 140, the outer conductor 130, the insulating portion 120, and the inner conductor 110 are all manufactured with the same lengths and the outer conductor 130, the insulating portion 120, and the inner conductor 110 are all concealed inside the jacket portion 140.

In this initial state, first, the jacket portion 140 is removed to a first predetermined length L1 so that the outer conductor 130 is exposed to the outside (see FIG. 2).

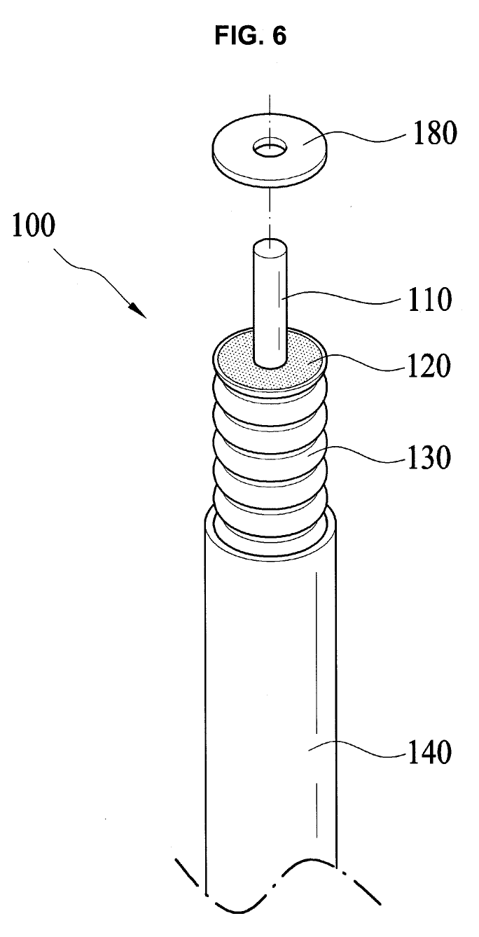

Thereafter, while the outer conductor 130 and the insulating portion 120 are removed to a second predetermined length L2 so that the inner conductor 110 is exposed to the outside while the outer conductor 130 is exposed to a third predetermined third length L3, and the coaxial cable 100 formed above is as illustrated in FIGS. 2 and 6.

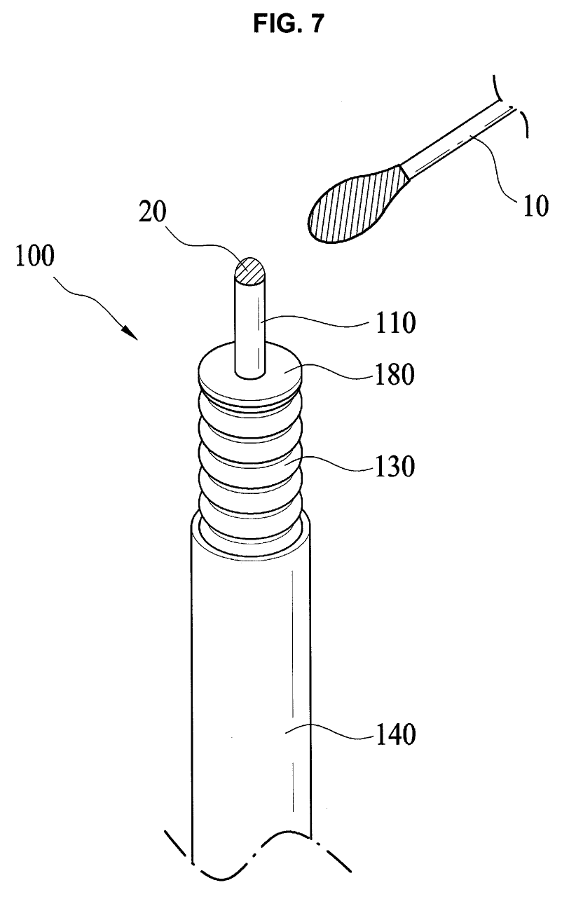

Next, as illustrated in FIG. 6, the front-closed circular board 180 having the central hole through which the inner conductor 110 passes is inserted to the insulating portion 120 so as to face each other. Then, as illustrated in FIG. 7, the flux 20 may be applied to the end of the inner conductor 110 by using a separate application tool 10 such as a cotton swab.

The flux applied to the present invention may be applied to the technique of Korean Paten Application No. 10-2010-0064024.

Meanwhile, after the flux is applied, the connecting pin 150 is installed at the end of the inner conductor 110, which is preferably performed as follows.

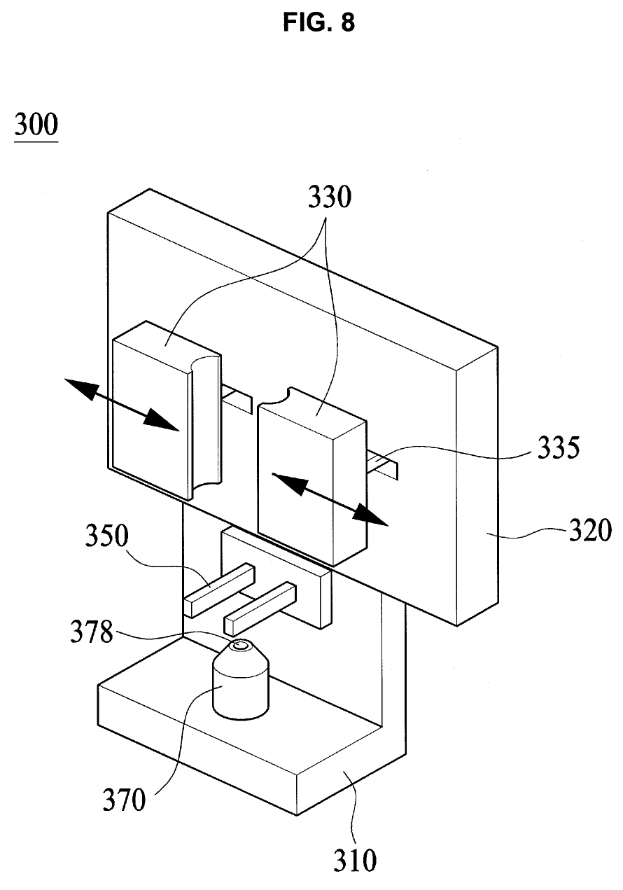

FIG. 8 is a perspective view schematically illustrating a coupling device for coupling the coaxial cable and the coaxial connector according to the present invention, and a coupling device 300 for the coaxial cable according to the present embodiment includes a base portion 310 and a support portion provided on the base portion 310.

A connection pin fixing portion 370 having a pin insertion groove 378 into which a pin 151 of the connection pin 150 is inserted is provided on the base portion 310.

In addition, the support portion 320 is provided with a fixing block 330 connected to a separate moving device (not illustrated) by a connection rod 335 so as to be movable left and right to both sides of the connection pin fixing portion 370. One of various known techniques may be applied to the moving device, and the fixing block 330 serves to fix the coaxial cable 100.

In addition, a high-frequency supply portion 350 is provided on both sides spaced apart from the connection portion 152 to the lower portion of the fixing block 330 and the upper side of the connection pin fixing unit 370.

The high-frequency supply portion 350 is configured to supply a high frequency to a portion where the inner conductor 110 is inserted into the connection portion 152 and then the two members are coupled to each other. Since it is obvious to those skilled in the art, the detailed description of the high-frequency supply portion 350 will be omitted.

As illustrated in FGI. 9, in the coupling device 300 formed above, while the pin portion 151 of the connection pin 150 is inserted into the pin insertion hole 378 of the connection pin fixing unit 370, the connecting portion 152 having a larger diameter than the pin portion 370 is installed so as to be exposed to the outside of the upper side of the connecting pin fixing portion 370.

Thereafter, a predetermined size of lead 30 is injected into the insertion groove 153 of the connection portion 152, which is opened to the upper side.

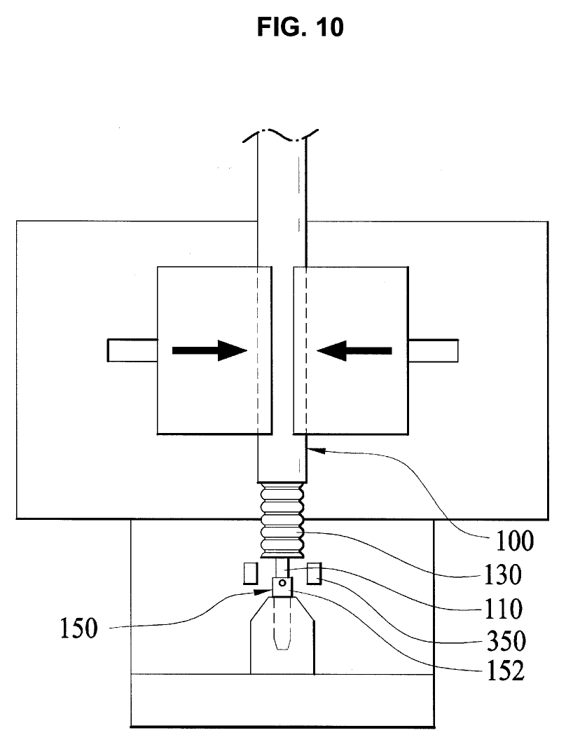

Next, as illustrated in FIG. 10, while the end of the inner conductor 110 is inserted into the insertion groove 153, the coaxial cable 100 is fixed to the insertion groove 153 using the fixing block 330 and a high frequency is supplied by the high-frequency supply unit 350 to melt the lead and simultaneously, the inner conductor 110 and the connection pin 150 are coupled to each other by the applied flux.

At this time, the lead and the flux enable a firm coupling state between the inner conductor 110 and the connection pin 150.

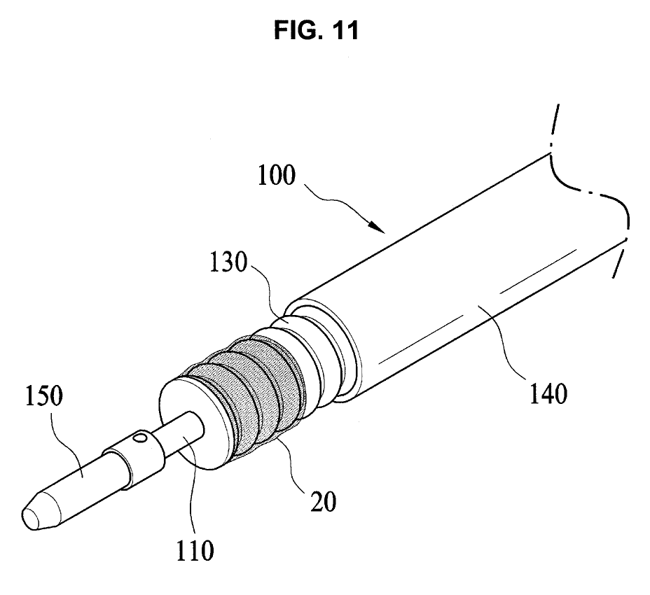

Next, as illustrated in FIG. 11, after applying the above-described flux 20 to the end of the outer conductor 130 by using a separate tool, the inner tube portion 212 of the connector main portion 210 is provided at the end of the outer conductor 130.

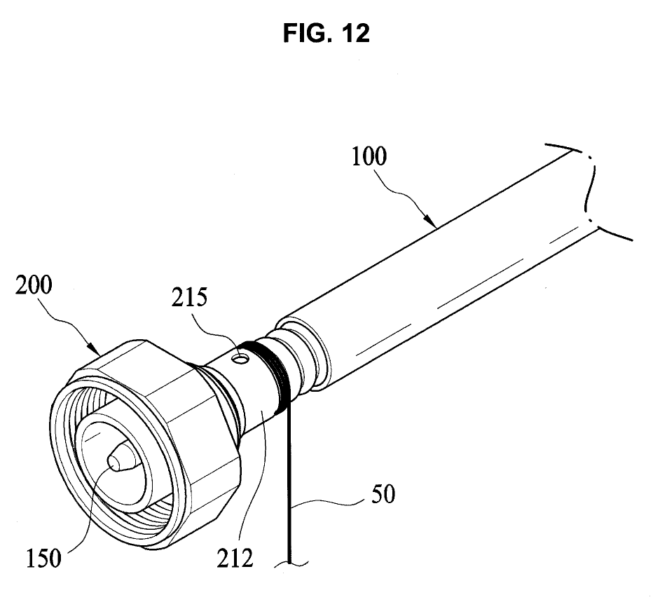

Thereafter, as illustrated in FIG. 12, a step of covering the thin lead 50 around the outside of the end outer conductor 130 of the installed connector main part 210 is performed.

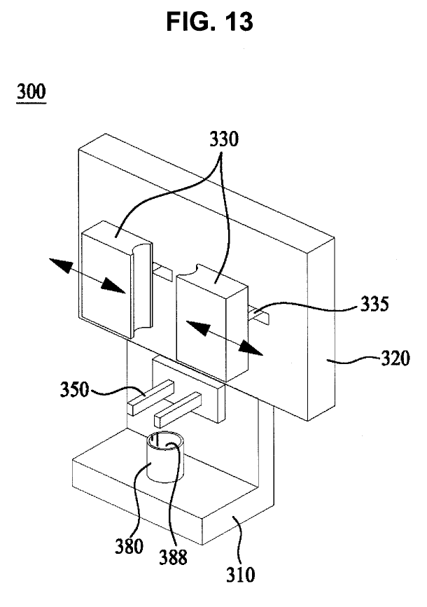

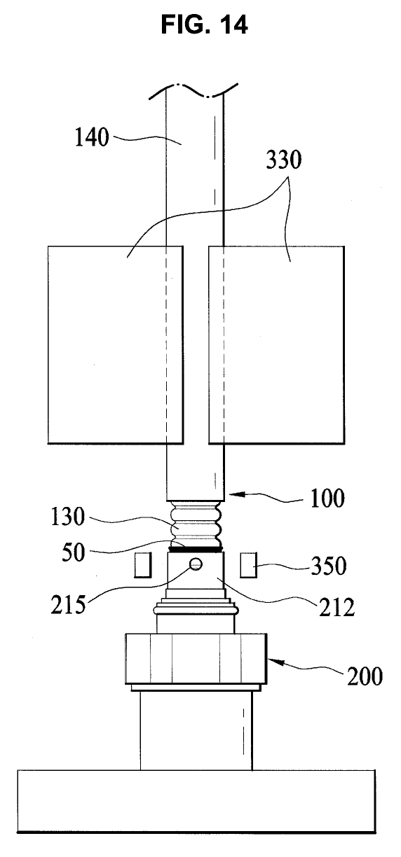

In such a state, as illustrated in FIG. 13, the fixing portion 380 having a insertion portion 388 into which the front side of the coaxial connector 200 is inserted is provided in the base portion of the coupling device 300 instead of the connecting pin fixing portion 370. Thereafter, as illustrated in FIG. 14, THE coaxial cable 100 is fixed using the fixing block 330 while the front outer tube portion 211 of the coaxial connector 200 is inserted and fixed to the fixing portion 380.

Then, by using the above-described high-frequency supply portion 350, the high frequency is supplied to the portion where the coaxial connector 200 and the coaxial cable 100 are coupled to each other.

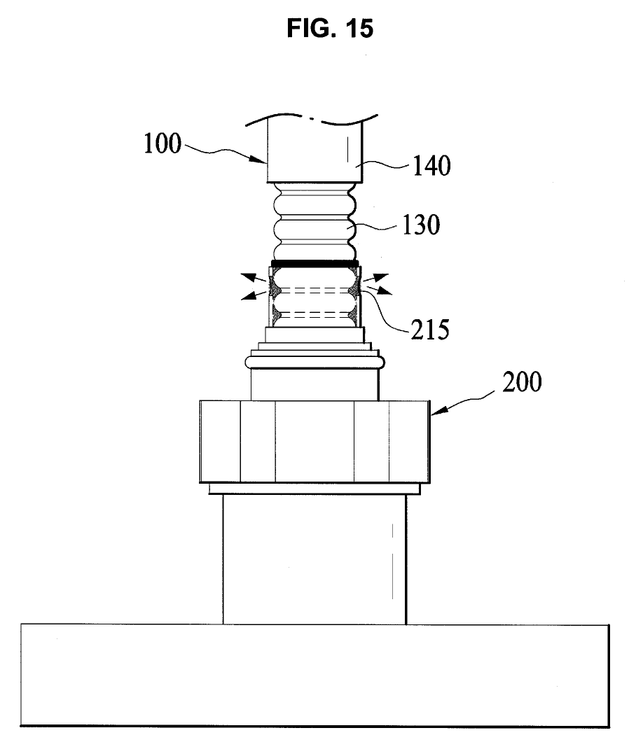

Meanwhile, as illustrated in FIG. 15, the inner tube portion 212 has a second air passage hole 215 of which an inner space portion communicates with the outer portion, and in this case, the inner tube portion 212 moves downward by using air discharged through the second air passage hole 215 through the portion where the coaxial connector 200 and the out side of the outer conductor 130 of the coaxial cable 100 are coupled to each other, that is, a self weight while closing a space between the coaxial connector 200 and the coaxial cable 100 after the thin lead 50 covered around the outside of the coaxial connector 200 is melted. In this case, the melted lead is naturally penetrated and applied between the inner tube portion 212 and the outer conductor 130 over a large area using a flow of the air discharged through the second air passage hole 215, thereby increasing a coupling force between the coaxial connector 200 and the coaxial cable 100 together with the flux.

The same effect is applied when the connection pin 150 and the internal conductor 110 are coupled to each other through the first air passage hole 155 provided in the connection pin 150.

Through the above-described process, after the coupling between the coaxial cable 100 and the coaxial connector 200 is completed, a separate performance test and a step test of the connection pin 150 exposed to the inside of the front side of the coaxial connector 200 are performed, and then the entire assembly process is completed.

According to the manufacturing method for the aluminum coaxial cable provided with the coaxial connector according to the embodiment of the present invention, it is possible to enable the combined operation using the lead by using the flux when combining the coaxial cable and the coaxial connector.

Further, it is possible to improve the product reliability and reduce the product defect rate by eliminating a simple mechanical coupling and inducing the integral coupling of the configurations using the flux.

As described above, those skilled in the art will be able to understand that the present invention can be easily executed in other detailed forms without changing the technical spirit or an essential feature thereof. Therefore, it is to be understood that the above-described embodiments are illustrative and not restrictive in all respects. The scope of the present invention is represented by claims to be described below rather than the detailed description, and it is to be interpreted that the meaning and scope of the claims and all the changes or modified forms derived from the equivalents thereof come within the scope of the present invention.

### EXPLANATION OF REFERENCE NUMERALS AND SYMBOLS

100: Coaxial cable

110: Inner conductor

120: Insulating portion

130: Outer conductor

140: Jacket portion

150: Connection pin

151: Pin portion

152: Connection portion

153: Insertion groove

155: First air passage hole

200: Coaxial connector

210: Connector main portion

215: Second air passage hole

220: Coupling nut portion

What is claimed is:

1. A manufacturing method for an aluminum coaxial cable provided with a coaxial connector, which includes a coaxial cable including an inner conductor having a predetermined length, an insulating portion covering the outside of the inner conductor so that the end of the inner conductor is exposed to the outside, an outer conductor covering the outside of the insulating portion, a jacket portion covering the outside of the outer conductor, and a connection pin connected to the end of the inner conductor; and a coaxial connector including a connector main portion to which the end of the outer conductor is inserted, the manufacturing method comprising:
applying a flux to the exposed end of the inner conductor; and
coupling the inner conductor and the connection pin by heating a portion where the inner conductor and the connection pin are coupled to each other after injecting a predetermined amount of lead between the connection pin and the inner conductor end.

2. The manufacturing method of claim 1, wherein the connection pin has an insertion groove to which the end of the inner conductor is inserted, and the lead is injected to the insertion groove.

3. The manufacturing method of claim 1, wherein the portion where the inner conductor and the connection pin are coupled to each other is applied with high-frequency heating.

4. The manufacturing method of claim 1, further comprising:
applying a flux to the end of the outer conductor;
inserting the outer conductor end applied with the flux into the connector main portion; and
providing lead at the outside of the outer conductor to a position adjacent to the connector main portion.

5. The manufacturing method of claim 4, wherein the lead provided at the outside of the outer conductor is formed of string-shaped thin lead and the thin lead is wound around the outer conductor to be adjacent to the outside of the connector main portion.

6. The manufacturing method of claim 1, wherein the inner conductor includes
a central portion made of an aluminum material; and
an external skin portion made of a brass material and covering the central portion.
